(19) United States
(12) Patent Application Publication
(10) Pub. No.: US 2016/0113743 A1
(43) Pub. Date: Apr. 28, 2016

(54) Interdental Brush with Adjustable Bending Angles

(71) Applicant: Pau-Ling Lu, Kaohsiung City (TW)

(72) Inventor: Pau-Ling Lu, Kaohsiung City (TW)

(21) Appl. No.: 14/521,495

(22) Filed: Oct. 23, 2014

(51) Int. Cl. A61C 15/00; A46B 9/04

(52) U.S. Cl. CPC A61C 15/00; A46B 9/045

(57) ABSTRACT

An interdental brush includes a handle, a neck, a head and a mounting sleeve. The handle has an upper end provided with a positioning portion. The neck extends from an upper end of the positioning portion. The neck has a helical annular groove which makes the neck flexible and bendable so that the neck can be bent. The helical annular groove contains oblique veins so that the neck is kept at a determined bending angle. The mounting sleeve is mounted on a bottom end of the handle to lengthen the handle. Thus, the neck is bent freely and kept at a determined bending angle by provision of the helical annular groove so that the angle of the head can be adjusted arbitrarily.

### BACKGROUND OF THE INVENTION

1. Field of the Invention

The present invention relates to a dental tool and, more particularly, to an interdental brush.

2. Description of the Related Art

A conventional interdental brush 1 in accordance with the prior art shown in FIGS. 1 and 2 comprises a handle 11 and a head 12 mounted on the upper end of the handle 11. The head 12 has bristles 121. In operation, the teeth 13 of the user are arranged successively and are gradually contracted toward the center in an arcuate manner. The clearance 131 between the teeth 13 at the center is parallel with the head 12 so that the head 12 is directly inserted into the clearance 131 between the teeth 13 to clean the teeth 13 by the bristles 121. However, the clearance 131 between the teeth 13 at the inner portion of the user's mouth has a greater angle and is not parallel with the head 12 so that the head 12 is not easily inserted into the clearance 131 between the teeth 13, thereby decreasing the cleaning effect.

Another conventional interdental brush 10 in accordance with the prior art shown in FIGS. 3 and 4 comprises a handle 101 has an upper end provided with a positioning portion 102 extending sideward, and a head 103 mounted on the positioning portion 102 of the handle 101. Thus, a determined angle is defined between the handle 101 and the head 103 so that the head 103 easily inserted into the clearance 131 between the teeth 13 at the inner portion of the user's mouth. However, the angle between the handle 101 and the head 103 is fixed and cannot be adjusted, thereby decreasing the cleaning effect.

Another conventional interdental brush 2 (developed by the applicant) in accordance with the prior art shown in FIGS. 5 and 6 comprises a handle 21, a neck 22 mounted on the upper end of the handle 21, and a head mounted on the upper end of the neck 22. The neck 22 has a plurality of annular grooves 221 that are disconnected from each other. Thus, when a bending force is applied on the neck 22, the neck 22 can be bent by provision of the annular grooves 221 to adjust the angle of the head. The annular grooves 221 are arranged symmetrically and are equally distant from each other. However, the neck 22 will be sprung to the original straight state by its elasticity after the force applied on the neck 22 disappears, thereby causing inconvenience to the user.

### BRIEF SUMMARY OF THE INVENTION

The primary objective of the present invention is to provide an interdental brush with adjustable bending angles.

In accordance with the present invention, there is provided an interdental brush comprising a handle, a neck, a head and a mounting sleeve. The handle has an elongate shape to allow a user holding the handle. The handle has an upper end provided with a positioning portion. The neck extends from an upper end of the positioning portion. The neck has a helical annular groove which makes the neck flexible and bendable so that the neck can be bent. The helical annular groove contains oblique veins so that the neck is kept at a determined bending angle. The mounting sleeve is formed with a receiving chamber mating with a width of the handle. The mounting sleeve has an opening mounted on the positioning portion of the handle. The opening of the mounting sleeve has an interior provided with a positioning ring. The positioning ring is provided with a plurality of ribs extending toward the opening for locking and fixing the positioning portion of the handle so that the head is sealed in the mounting sleeve. The mounting sleeve is mounted on a bottom end of the handle to lengthen the handle.

According to the primary advantage of the present invention, the neck is bent freely and kept at a determined bending angle by provision of the helical annular groove so that the angle of the head can be adjusted arbitrarily, thereby facilitating the user cleaning the teeth.

According to another advantage of the present invention, the mounting sleeve can be mounted on the bottom end of the handle to lengthen the handle.

According to a further advantage of the present invention, the head is covered by the mounting sleeve when not in use to facilitate the user carrying the interdental brush.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front view of a conventional interdental brush in accordance with the prior art.

FIG. 2 is a schematic operational view of the conventional interdental brush as shown in FIG. 1 in use.

FIG. 3 is a front view of another conventional interdental brush in accordance with the prior art.

FIG. 4 is a schematic operational view of the conventional interdental brush as shown in FIG. 3 in use.

FIG. 5 is a perspective view of another conventional interdental brush in accordance with the prior art.

FIG. 6 is a locally enlarged front view of the conventional interdental brush as shown in FIG. 5.

FIG. 7 is an exploded perspective view of an interdental brush in accordance with the preferred embodiment of the present invention.

FIG. 8 is a front cross-sectional assembly view of the interdental brush as shown in FIG. 7.

FIG. 9 is a locally enlarged front view of a neck of the conventional interdental brush as shown in FIG. 7.

FIG. 10 is a schematic operational view of the interdental brush as shown in FIG. 7 in use.

FIG. 11 is a schematic operational view of the interdental brush as shown in FIG. 7 in use.

FIG. 12 is another front cross-sectional assembly view of the interdental brush as shown in FIG. 7.

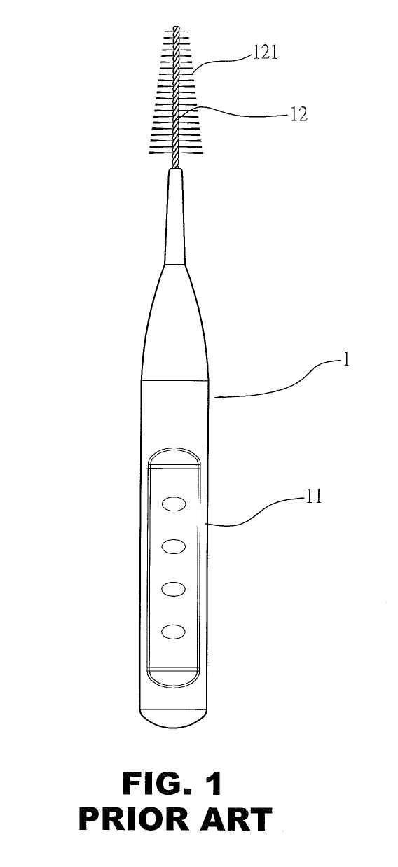

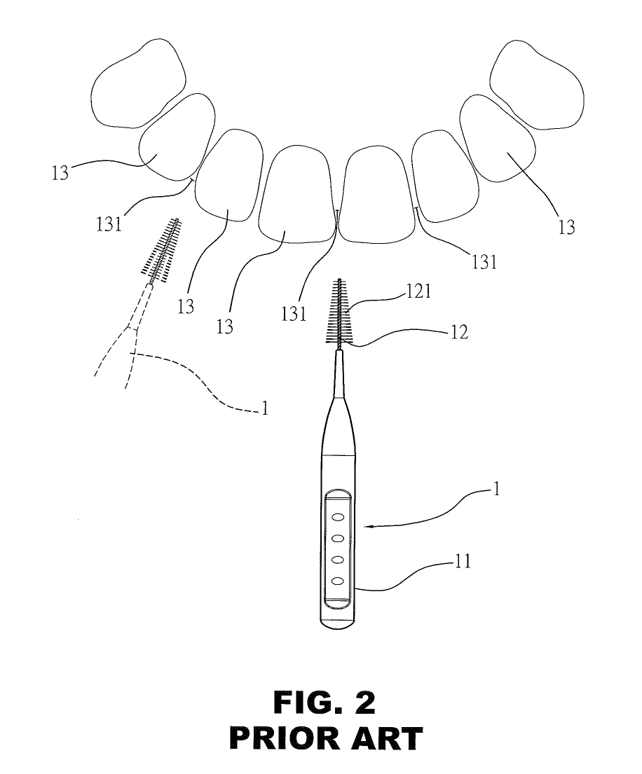

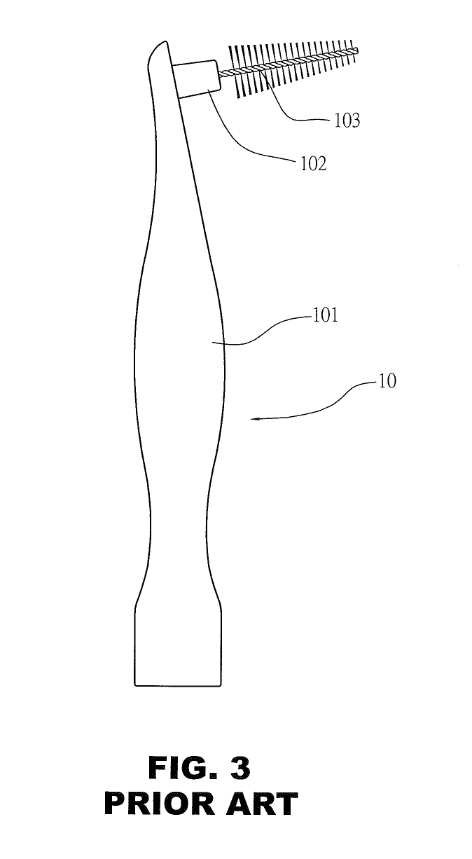

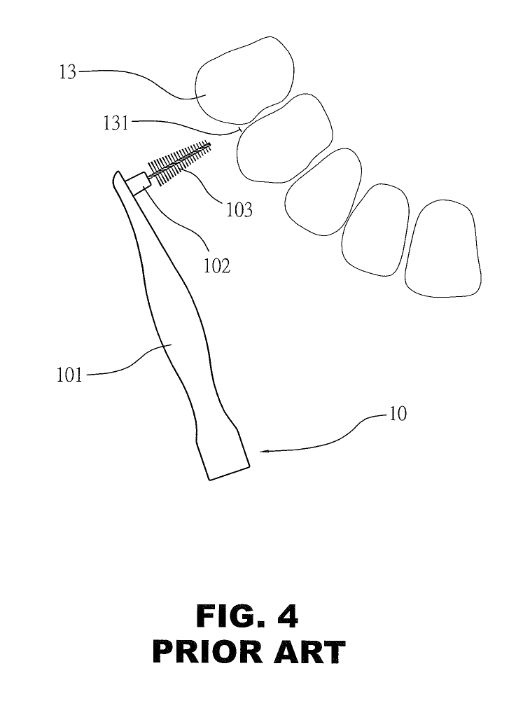

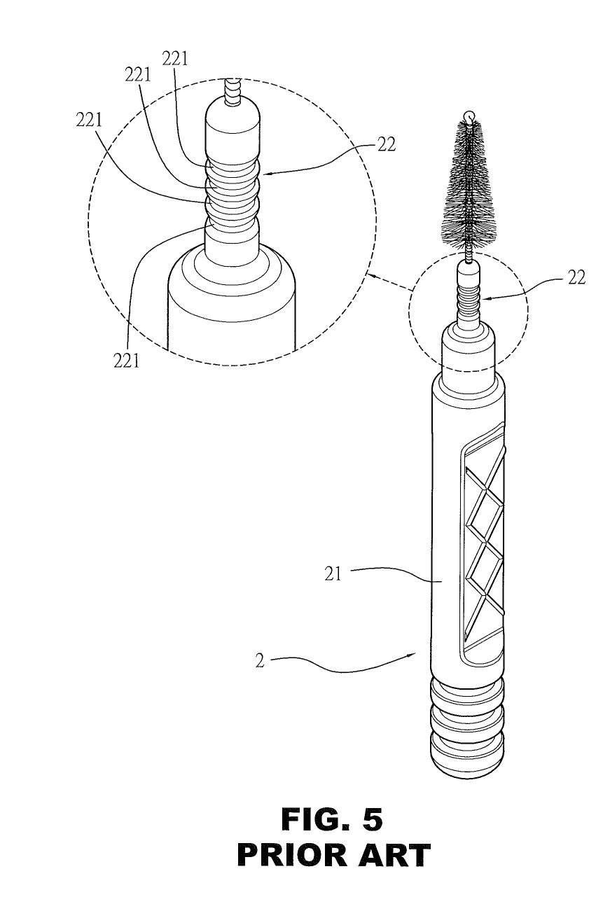

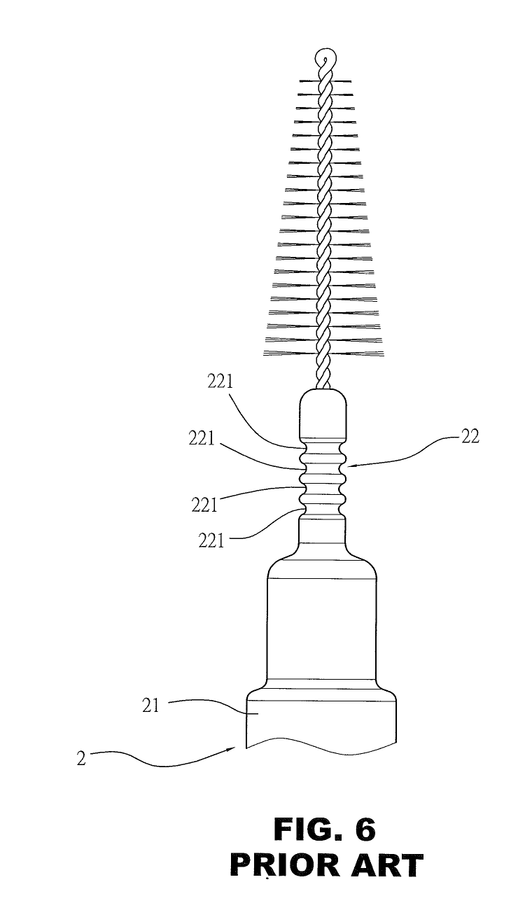

### DETAILED DESCRIPTION OF THE INVENTION

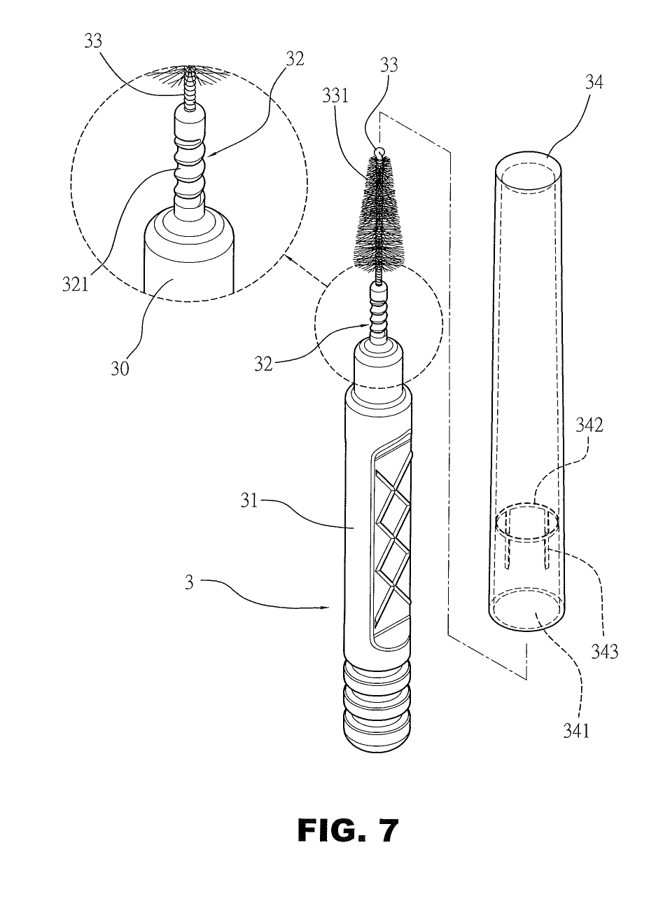

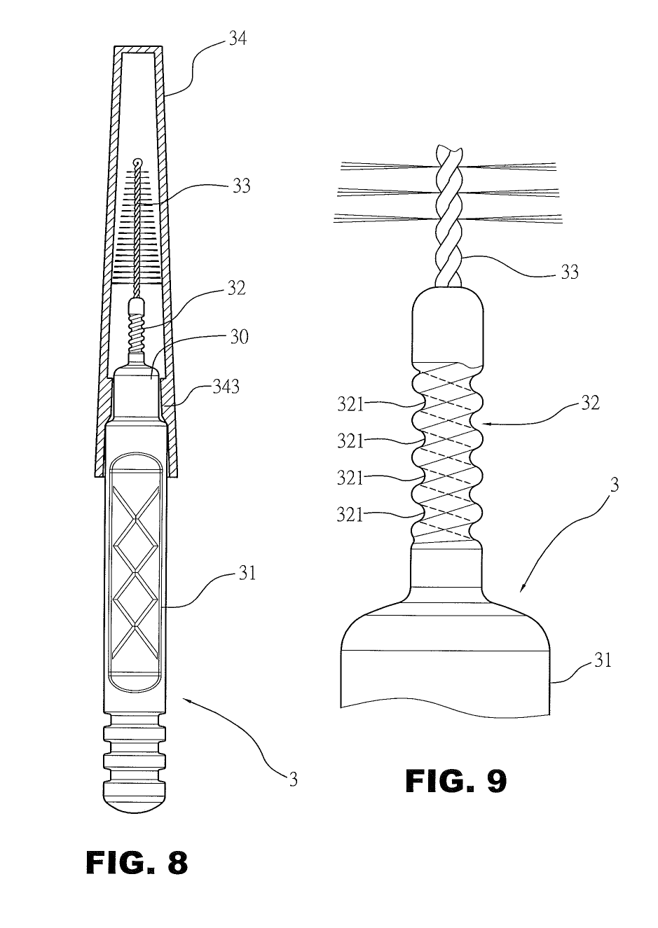

Referring to the drawings and initially to FIGS. 7 and 8, an interdental brush 3 in accordance with the preferred embodiment of the present invention comprises a handle 31, a neck 32, a head 33 and a mounting sleeve 34. The handle 31 has an elongate shape to allow a user holding the handle 31. The handle 31 has an upper end provided with a positioning portion 30. The neck 32 extends from an upper end of the positioning portion 30. The neck 32 has a helical annular groove 321 which makes the neck 32 flexible and bendable so that the neck 32 can be bent and positioned at a determined bending angle. The helical annular groove 321 contains oblique veins so that the neck 32 is kept at a determined bending angle and will not be sprung back. The head 33 is mounted on an upper end of the neck 32 and contains a plurality of soft bristles 331. The mounting sleeve 34 is formed with a receiving chamber mating with the width of the handle 31. The mounting sleeve 34 has an opening 341 having an interior provided with a positioning ring 342. The positioning ring 342 is provided with a plurality of ribs 343 extending toward the opening 341 for locking and fixing the positioning portion 30 of the handle 31. Thus, the head 33 is sealed in the mounting sleeve 34 as shown in FIG. 8 to provide a sanitary function and to facilitate the user carrying the interdental brush 3.

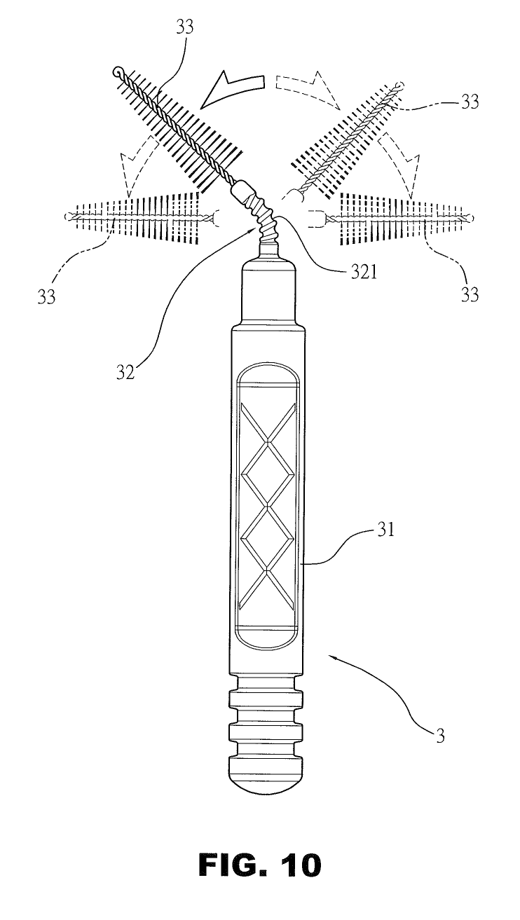

Referring to FIGS. 9 and 10, the neck 32 can be bent toward any direction by provision of the helical annular groove 321. In addition, the neck 32 is kept at a determined bending angle by provision of the helical annular groove 321 so that the neck 32 will not be sprung back after being bent. Thus, the neck 32 is bent to adjust the bending angle of the head 33 as shown in FIG. 10 according to the user's requirement so that the head 33 can clean the user's teeth exactly and completely.

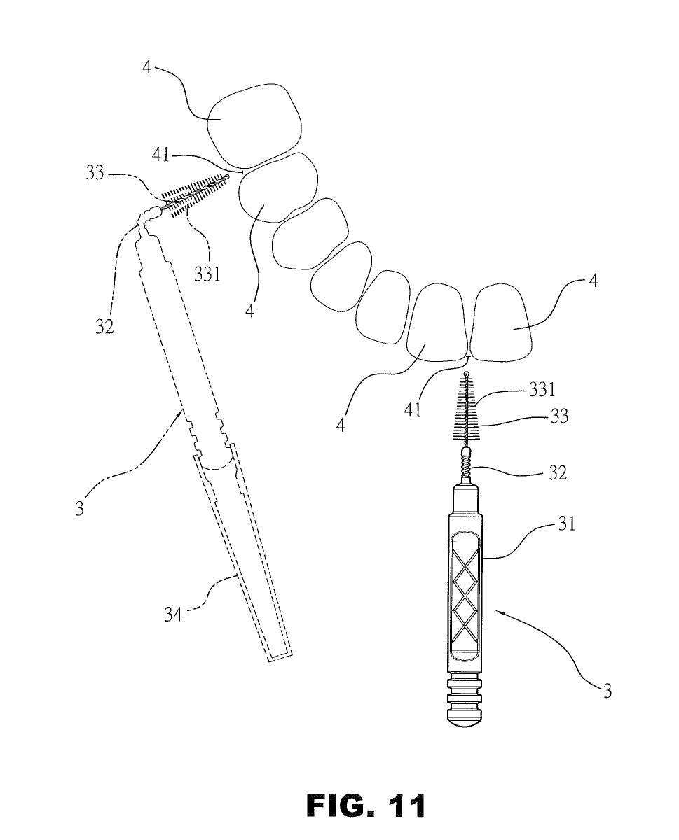

In operation, referring to FIG. 11 with reference to FIGS. 7-10, the teeth 4 of the user are arranged successively and are gradually contracted toward the center in an arcuate manner. The clearance 41 between the teeth 4 at the center is parallel with the head 33 so that the head 33 is directly inserted into the clearance 41 between the teeth 4 to clean the teeth 4 by the bristles 331. The clearance 41 between the teeth 4 at the inner portion of the user's mouth has a greater angle and is not parallel with the head 33 so that the head 33 cannot be directly inserted into the clearance 41 between the teeth 4. At this time, the user can apply a force on the neck 32 to bend the neck 32 so that the neck 32 is bent to adjust the bending angle of the head 33 to fit the angle of the clearance 41 between the teeth 4 at the inner portion of the user's mouth. In such a manner, the head 33 that has been bent is directly inserted into the clearance 41 between the teeth 4 to clean the teeth 4 by the bristles 331. At this time, the neck 32 is kept at the determined bending angle by provision of the helical annular groove 321 so that the neck 32 will not be sprung back after being bent. Thus, the neck 32 is bent freely to adjust the bending angle of the head 33 according to the user's requirement so that the head 33 can clean the user's teeth exactly and efficiently. In addition, the neck 32 is bent easily and conveniently, thereby saving the user's energy and time. Further, the neck 32 is bent smoothly so that the head 33 is not loosened easily, thereby enhancing the lifetime of the interdental brush 3.

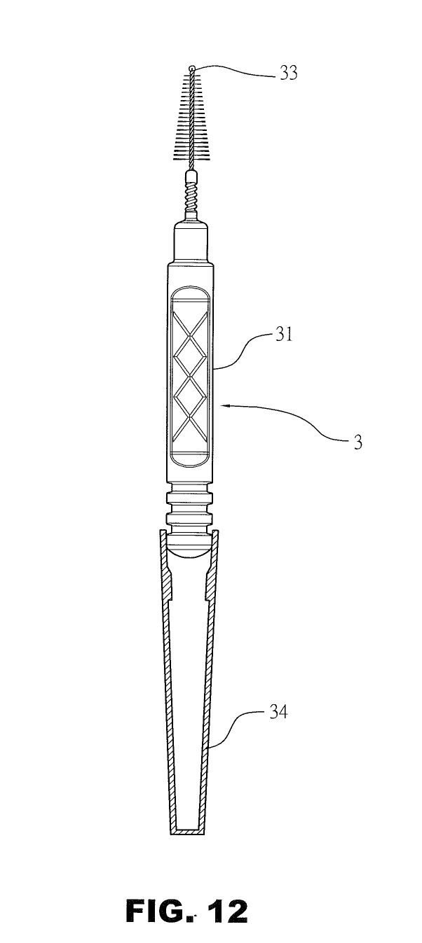

Referring to FIG. 12, the mounting sleeve 34 is mounted on the bottom end of the handle 31 to lengthen the handle 31, thereby facilitating the user cleaning the teeth.

Accordingly, the neck 32 is bent freely and kept at a determined bending angle by provision of the helical annular groove 321 so that the angle of the head 33 can be adjusted arbitrarily, thereby facilitating the user cleaning the teeth. In addition, the mounting sleeve 34 can be mounted on the bottom end of the handle 31 to lengthen the handle 31. Further, the head 33 is covered by the mounting sleeve 34 when not in use to facilitate the user carrying the interdental brush 3.

Although the invention has been explained in relation to its. preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An interdental brush comprising:
a handle, a neck, a head and a mounting sleeve;
wherein:
the handle has an elongate shape to allow a user holding the handle;
the handle has an upper end provided with a positioning portion;
the neck extends from an upper end of the positioning portion;
the neck has a helical annular groove which makes the neck flexible and bendable so that the neck can be bent;
the helical annular groove contains oblique veins so that the neck is kept at a determined bending angle;
the mounting sleeve is formed with a receiving chamber mating with a width of the handle; and
the mounting sleeve has an opening mounted on the positioning portion of the handle.

2. The interdental brush of claim 1, wherein:
the opening of the mounting sleeve has an interior provided with a positioning ring; and
the positioning ring is provided with a plurality of ribs extending toward the opening for locking and fixing the positioning portion of the handle so that the head is sealed in the mounting sleeve.

3. The interdental brush of claim 1, wherein the mounting sleeve is mounted on a bottom end of the handle to lengthen the handle.
